(19) United States
(12) Patent Application Publication
(10) Pub. No.: US 2023/0240206 A1
(43) Pub. Date: Aug. 3, 2023

(54) TREE SHELTER

(71) Applicant: NexGen Tree Shelters Limited, Ascot (GB)

(72) Inventor: Gary Hurlstone, Ascot (GB)

(21) Appl. No.: 18/003,475

(22) PCT Filed: Jun. 25, 2021
(86) PCT No.: PCT/IB2021/055688

§ 371 Date: Dec. 27, 2022

(30) Foreign Application Priority Data
Jun. 29, 2020 (GB) 2009871.1
Dec. 24, 2020 (GB) 2020628.0

(51) Int. Cl. A01G 13/02; D04H 1/4266; D04H 1/52

(52) U.S. Cl. CPC A01G 13/0243; D04H 1/4266; D04H 1/52

(57) ABSTRACT

A tree shelter comprising an elongate tubular body having a wall formed from a biodegradable material comprising a natural fibre substrate and a matrix of a natural binder in which the fibres are held.

### TECHNICAL FIELD

The present invention relates generally to tree shelters.

### BACKGROUND

Tree shelters are known to have been used from as early as 1979 to provide physical protection for sapling trees, for example against wind and animal damage as well as providing a barrier to chemical spray. After about five years of growth the tree shelter is removed or breaks away, allowing the tree to increase in girth and for the root system to further develop.

Known tree shelters are generally tubular structures that are secured in position around the young tree and are typically formed from a transparent or translucent plastics material, allowing sunlight into the interior of the tube. In addition to protecting the young trees from damage, tree shelters are known to provide a green-house-like micro-climate within the tube that promotes tree growth. The tree shelters are typically secured to a wooden stake with one or more plastic ties to hold them in place.

One relatively early example of a tree shelter is seen in WO 87/01904 (Tubex). The shelter described in this document includes a tubular extrusion of a UV-degradable, translucent polypropylene. The tube has a longitudinally extending external v-section channel to receive a wooden stake, to which the tube is secured with two plastic cable ties. The UV-degradable polypropylene is selected such that the tree shelter will degrade over time and eventually disintegrate after about 5 to 7 years (dependent on the environmental conditions where the tube is installed).

WO 91/15946 (Tubex) describes a similar tree shelter to the shelter described in WO 87/01904 but which includes an angled bottom end provided with the intention that the tube can be driven into the ground to be secured in place without the need for a stake. The tube of the tree shelter described in this document is also formed with one or more lines or weakness (e.g. slits) extending longitudinally on the tube wall to facilitate the tube being opened out or split apart by the growth of the tree.

EP 0558356 (Tubex) describes another tree shelter of the same general form as those already described, with the addition of one or more ventilation holes towards a lower end of the tube, whereby a ‘chimney effect’ is created, with an upward flow of air being induced in the tube to help meet the carbon dioxide demand of a tree enclosed in the shelter.

It has been previously proposed to form tree shelters from biodegradable materials, including for example biodegradable biopolymers, such as polyactide (PLA) and starch and plant-derived polyester polymers, as well as biocomposites including biopolymers along with reinforcing filler materials such as waste paper sludge, wood fibres, jute, flax, hemp and straw. GB 2442333 (Tubex) described the use of these biodegradable materials but highlights associated problems, including a lack of transparency, a lack of structural integrity and limited life due to rapid degradation. To address these problems, GB 2442333 proposed the use of a degradation resistant coating on biodegradable tree shelter tube structure that has openings to permit ingress of light, the coating being a film of polypropylene (PP), polyethylene (PE), polyvinyl chloride (PVC or polyester (PET).

Despite the innovations described in the patent applications noted above, the vast majority of tree shelters in use today still have the same basic form as those described in WO 91/15946, including a plastic (e.g. polypropylene) tube, secured to a wooden stake with plastic (e.g. nylon) ties. Whilst 30 years ago the degradable nature of the plastics used for these tree shelters was seen as a positive feature, as it meant that the shelters did not have to be manually removed as the tree grew, the detrimental environmental impact of plastics as they break down, leaving micro- and eventually nano-particles of plastic in the environment, is now well understood and there is pressure on land owners to recover the tree shelters before they disintegrate and for the material from the used tree shelters to be recycled, adding to the overall ‘lifetime’ cost of each shelter.

### SUMMARY OF INVENTION

Embodiments of the invention are generally aimed at providing tree shelters that continue to provide the benefits of conventional plastic shelters whilst eliminating, or at least significantly reducing, the environmental damage caused by conventional plastic tree shelters when they are left to degrade in the countryside.

With this aim in mind, it is proposed that embodiments of the invention provide tree shelters using a tube formed from a bio renewable substrate combined with an environmentally friendly resin. It has been found through careful selection of the substrate and resin it is possible to form a tree shelter having desired characteristics, namely a lightweight tubular structure with walls that are hydrophobic, semitransparent (translucent), UV resistant, antimicrobial, smooth surfaced and lightweight.

In a first aspect, the invention provides a tree shelter comprising an elongate tubular body having a wall formed from a biodegradable material comprising a natural fibre substrate and a matrix of a natural binder (e.g. natural resin) in which the fibres are held.

In some embodiments, the biodegradable material from which the tree shelter wall is formed is translucent or transparent. Preferably the wall is at least 50% translucent, more preferably at least 70% translucent or even 80% translucent or more. This can ensure that sufficient light reaches the interior of the tree shelter to support the photosynthesis required for growth of the tree.

Beneficially, in some embodiments, refraction of the light as it passes through the tree shelter wall can mean that the transmitted light is incident on the internal wall of the tube at an angle where a significant proportion of the light is reflected and thus retained in the tube of the tree shelter. This helps increase the light levels within the tube to ensure that the tree (or other plant) within the shelter receives adequate light to enable the necessary photosynthesis for plant growth.

In some embodiments the natural fibre is plant fibre. For example, the fibre could be any one of paper pulp, wood pulp, coffee husks, rice husks, ground rice husks, cotton (e.g. recycled cotton) and bamboo or a combination of any two or more of these fibres.

Alternatively, in some embodiments the natural fibre is animal fibre, for example wool, goat hair (e.g. mohair, cashmere), alpaca and angora, or a combination of any two or more of these fibres.

Wool has been found to be a particularly suitable natural fibre for use in the proposed new material. Wool has a high nitrogen content, crucial in supporting plant growth. Thus, as the tree shelter degrades and the wool fibres are dispersed around the base of the tree it helps to support plant growth. More specifically, a benefit of using wool is that it acts as a trigger to start the biodegradation process. When the strands of wool, which have had the lanolin removed, become exposed to the natural elements, the degradation process runs up the strands of wool and breaks down the tree shelter into nitrogen, CO² and H²O. The tree shelter will start to break down after 5 years, depending on its location.

Using wool also has significant environmental benefits, especially as the newly proposed material can make use of waste wool, which currently is disposed of by burning. Not only does the use of wool in tree shelters make use of this waste material but, in doing so, it helps support a large community of small sheep farmers.

Some embodiments may use a combination of one or more types of plant fibre and one or more types of animal fibre.

In some embodiments, the natural binder is a plant or insect derived natural binder. The binder may, for example, be derived from a natural plant based polyol such as a cashew nut shell liquid (CNSL) based polyol, a castor nut oil based polyol or a polyol based on a combination of CNSL and castor nut oil. In some embodiments, the binder may be a natural, thermoplastic polyurethane (TPU), for example a TPU derived from a natural plant based polyol such as a cashew nut shell liquid (CNSL) based polyol or a polyol based on a combination of CNSL and castor nut oil. The binder may also include a catalyst component or other components, examples of which are well known to the skilled person, if desired or required, for example to help bind the two materials.

One specific combination of materials that has been found to be particularly suitable for use in the wall structure of a tree shelter is a material using wool and with a binder derived from a cashew nut shell liquid (CNSL) and castor nut oil based polyol. Using a CNSL and castor nut oil based polyol for the binder allows greater control over the physical characteristics of the wall structure, including its flexibility, strength and translucency, by varying the proportions of the two components.

It has also been shown that these natural plant based binders release carbon dioxide as they degrade over time, further supporting plant growth within the tree shelter.

Conveniently, the wall of the elongate tubular body can be formed, in some embodiments, from a sheet of the biodegradable material formed into a tube with opposite edge portions of the sheet overlapping one another to form a double thickness wall region in the formed tube. This configuration provides a stronger region of the wall, where the edge portions overlap, which may be desirable for attachment of the tree shelter to a stake. The width of the double thickness wall region is preferably selected to be similar in size to the width of the stake to which the tree shelter is to be attached, to provide adequate strength for attachment to the stake, whilst minimizing the amount of overlap. If the overlap is too great, it leads to unnecessary, excess material being used and having too large of a double wall section can be detrimental to the light transmission through the tube wall. Typically the overlap is at least 20 mm. More preferably it is at least 30 mm. Generally the overlap will be no more than 40 mm.

In some embodiments the overlapping ends of the sheet are bonded to one another during manufacture. For example, where the wall material is a thermoset the overlapping wall portions may be pressed and cured to bond them to one another, having first been formed into a tube around a mandrel.

In some embodiments, to facilitate attachment to a stake, the double thickness wall region comprises attachment formations, such as holes. For example, the attachment formations can include at least one pair of holes extending through one or both of the overlapping portions of the sheet, with the holes in opposite end portions of the sheet being brought into alignment with one another when the tube is formed. In this way, the tree shelter can be secured to the stake by passing opposite ends of a strap from within the tube through a respective hole to the outside of the tube around opposite sides of the stake and securing the ends of the strap together. Preferably there are at least two straps space apart longitudinally along the tube wall (with corresponding spaced apart pairs of holes).

Whilst it would be possible to use conventional nylon ties as the strap to secure the tree shelter to the stake, it is preferable to use non-plastic ties, for example metal ties.

Advantageously, in some embodiments, the pairs of holes are spaced so that respective inside edges of the two holes (i.e. the portions of the edges of the holes that are closest to one another) are spaced from one another by an amount that is greater than the width of the stake to which the tree shelter is to be secured. In this way, as the tie (e.g. metal tie) is tightened about the stake in use, the tie is first pulled taught against the inside edges of the hole and then, as the tie is tightened further, the tie cuts into the wall of the tree shelter adjacent the inner edges of the holes, more securely fixing the tree shelter to the stake.

In some embodiments where metal ties are used, the size, shape and material composition of the tie is selected so that the tie erodes, based on assumed environmental conditions, at a rate that gives the tie a life commensurate with the life of the tree shelter, for example about 5 years. In other embodiments, the metal ties may be engineered to erode at a quicker rate than the tree shelter so that it falls away from the tree shelter whilst the shelter is still intact and surrounding the tree. This releases the tree shelter from the stake.

In embodiments where the overlapping wall portions of the tree shelter wall are held together by the ties (rather than being bonded), when the ties fall away they also release the overlapping wall portions from one another, allowing the tree shelter to expand as the girth of the tree increases, reducing the risk that the tree is strangled by the shelter. In some embodiments, this approach avoids the need for lines of weakness, described below.

In some embodiments, a top end portion of the wall of the elongate tubular body is flared outwardly or rounded. This helps to avoid damage to the sapling tree as it grows and emerges from the top of the tree shelter.

In some embodiments, a plurality of ventilation holes are provided in the wall of the elongate tubular body to allow some flow of air into and through the tree shelter. Where such holes are provided, however, it is preferred that they are not included in a bottom portion of the wall (nearest to the ground) so that herbicides (or other agents) can be safely sprayed on the ground adjacent the tree shelter without risk of them being sprayed through the ventilation holes into the interior of the shelter. Typically, it will be desirable to avoid having ventilation holes in at least the bottom 0.4 to 0.45 m of the wall.

In some embodiments the tree shelter includes at least one longitudinal line of weakness in the wall of the tubular body extending the full height of the wall. The line of weakness may be provided, for example, by a series of slits in the wall, or a reduced thickness line in the wall. There may be more than one line of weakness, for instance two diametrically opposed lines of weakness. With this configuration, if the tree outgrows the shelter before the shelter has degraded, the tree will force the shelter wall apart along the line (or lines) of weakness so that the growth is not restricted. The use of wool ensures that the slits recover once cut, which allows the line of weakness to remain but the slit portion of the tube still acts as an effective barrier to herbicides entering the tree shelter.

In a second aspect, the invention provides a tree shelter comprising an elongate tubular body having a wall formed from a sheet material formed into a tube with opposite edge portions of the sheet overlapping one another to form a double thickness wall region in the formed tube.

As in the first aspect, the width of the double thickness wall region is at least 20 mm so as to provide strength for attachment to a stake, for example using holes in the wall as described above.

This configuration provides a very simple way of constructing the tree shelters, even on site in some cases, with the tubular form being maintained by the straps that are also used to attach the tree shelters to the stakes. In other embodiments the overlapping wall portions may be bonded to one another during manufacture.

In a third aspect the invention provides a tree shelter comprising an elongate tubular body having a wall formed from a biodegradable non-plastic material, at least one pair of holes extending through the wall, and a metal tie strap, whereby the tree shelter can be secured to a stake by passing opposite ends of the metal tie strap from within the tube through a respective hole to the outside of the tube around opposite sides of the stake and securing the ends of the metal tie strap together.

In some embodiments, the metal (or other) tie can be configured once added to the tube to have a shape that makes installation easy. For example, the tie can be formed into a generally square shape to receive the stake when the tree shelter is installed. With this approach, the ends of the tie can also be twisted together prior to installation (e.g. as part of the tube manufacture), so that all that is required for installation is for the user to apply a few additional twists to tighten the tie once the shelter is in position with the stake passing through the tie. This is particularly beneficial when the installer will be wearing gloves, as is often the case, as they do not have to initially twist the ends of the tie together, which can be difficult without bare hands.

This enables an entirely non-plastic construction, with both the tubular body and the metal tie being able to degrade without leaving damaging micro- and nano-plastic particles.

As in the first aspect, the pairs of holes can be spaced so that respective inside edges of the two holes are spaced from one another by an amount that is greater than the width of the stake to which the tree shelter is to be secured. In this way, as the metal tie is tightened about the stake in use, the tie cuts into the wall of the tree shelter adjacent the inner edges of the holes, more securely fixing the tree shelter to the stake.

The holes may be formed either side of the overlapping, double thickness portion of the tube wall.

In a fourth aspect the invention provides a biodegradable sheet material comprising a natural fibre substrate and a matrix of a natural binder in which the fibres are held, wherein the natural fibre is wool (e.g. recycled wool), goat hair, alpaca and angora, or a combination of any two or more of these fibres, and the binder is derived from a natural plant based polyol. In one example, the natural fibre is wool and the binder is derived from a cashew nut shell liquid (CNSL) and castor nut oil based polyol.

In addition to tree shelters, it is envisaged that this material will have multiple other uses in forestry, agriculture, horticulture and viticulture, including for example for us in soil replenishment and, more generally as a replacement for poly-sheets, as horticulture ground cover, as silage wraps, as other temporary coverings and for packaging.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

### BRIEF DESCRIPTION OF THE DRAWINGS

FIG. 1 shows an elevation of a tree shelter according to an embodiment of the invention;

FIG. 2 is a top plan view of the tree shelter of FIG. 1;

FIG. 3 illustrates a process for constructing the tree shelter of FIG. 1;

FIGS. 4a, 4b and 4c illustrate the steps of attaching a tree shelter to a stake with a tie (e.g. a metal tie);

FIG. 5 illustrates a preferred light transmission spectrum for the walls of a tree shelter; and

FIG. 6 shows light transmission spectrum results from a test of a material made in accordance with an embodiment of the present invention.

### DETAILED DESCRIPTION OF THE EMBODIMENT

An embodiment is described below by way of example with reference to the accompanying drawings.

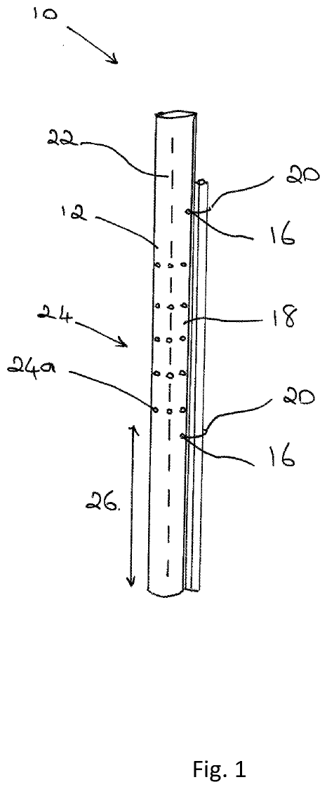

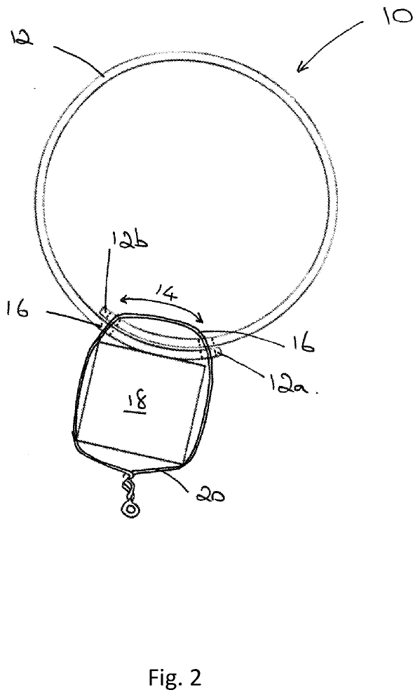

The tree shelter 10 illustrated in FIGS. 1 and 2 addresses problems identified with known tree shelters by providing a sustainable, biodegradable, non-plastic alternative, whilst retaining desired characteristics including a translucent, hydrophobic and UV resistant wall, along with the required strength to provide the desired physical protection for a sapling tree.

The tree shelter 10 in the illustrated example has an elongate, tubular body 12 formed from a sheet of material that is rolled into a tube, with opposite edge portions 12a, 12b of the sheet overlapping to form a double-walled portion 14 (as best seen in FIG. 2). In this example the tube 12 has a generally circular cross-section but other cross-sectional shapes can be used.

The overlapping wall portions include wire tie attachment holes 16 towards the top and towards the bottom of the tube, via which the tube can be secured to a stake 18 (typically a wooden stake) by metal ties 20. The overlapping portions have pairs of holes 16 that are brought into alignment when the ends 12a, 12b of the sheet are overlapped, allowing opposite ends of a metal tie 20 to be pushed from the inside of the wall portion through respective aligned holes 16 so as to protrude outwardly from the tree shelter wall. The ties 20 can then subsequently be used to secure the shelter to the stake 18, as described further below. In the illustrated example, the ties pass from the inside of the tube through both overlapping ends 12a, 12b of the sheet. In other examples, the ties 20 may pass through holes only in the outer of the two overlapping ends of the sheet, so that the inner part of the tie is between the two overlapping ends 12a, 12b.

The tree shelters 10 can be formed in any number of different sizes. Typically, they will have diameters (inside and/or outside) in the range of about 7 cm to about 20 cm. The dimensions need not be precise and manufacturing tolerances need not be tight, so diameters may vary by a few millimeters from tube to tube. Typically, tree shelters for tree saplings will have diameters between 7 cm and 12 cm, tree shelters for shrubs will typically have larger diameters up to 20 cm, and tree shelters for vines (“vine shelters”) will have diameters similar to those of a shelter for tree saplings. The heights of the tubes typically range from 0.6 m to 1.2 m. Whilst taller tubes could easily be manufactured, they become cumbersome to handle and if a taller shelter is required it is more usual to stack two shelters on top of one another (e.g. to put a 0.6 m tube or a 0.75 m tube on top of a 1.2 m tube). The tube wall thickness will generally be in the order of a few millimeters, for example 2 to 3 mm. The wall overlap 14 will generally be 20 cm to 40 cm, with 30 cm being a typical overlap.

The sheet material from which the tree shelter body 12 is formed is a natural fibre, wool in this example, in a matrix of a natural binder, in this example a TPU binder derived from a cashew nut shell liquid (CNSL) and castor nut oil based polyol.

These materials are naturally hydrophobic, UV resistant and resistant to microbes. They can be formed into a sheet material that has the desired semitransparent (i.e. translucent) characteristic to ensure sufficient light can penetrate the tube wall, as well as being smooth surfaced (to avoid damage to the sapling tree growing inside), lightweight and sufficiently strong to protect the tree from wind and animal damage. The material also provides an effective barrier to herbicide spray.

The wall of the shelter includes a line of spaced apart slits 22 through the wall, the line extending from the top of the tube 12 to the bottom. There is a corresponding line of slits diametrically opposed on the other side of the shelter (although in some embodiments only a single line of slits is used). The slits 22 provide lines of weakness, as discussed above, so that the tree can push apart the tubular shelter wall as the tree grows.

In embodiments where the overlapping portions 12, 12b of the tube are held together by the ties, in addition to the slit lines, or as an alternative, the metal ties 20 can be designed (in terms of materials, shape and size) to erode at a rate that means they rust away within a desired time frame (4 to 5 years), thus releasing the tree shelter 10 from the stake 18 and releasing the overlapping wall portions 12a, 12b of the shelter from one another. This allows the tree shelter wall to expand as the growing tree pushes against it.

The wall of the shelter also includes an array of ventilation holes 24. These extend in several rows, one above the other, around the full circumference of the wall. The lowest row of ventilation holes 24a is at least 0.45 m from the bottom of the tube, to provide a herbicide resistant base portion 26 of the tube, as discussed above.

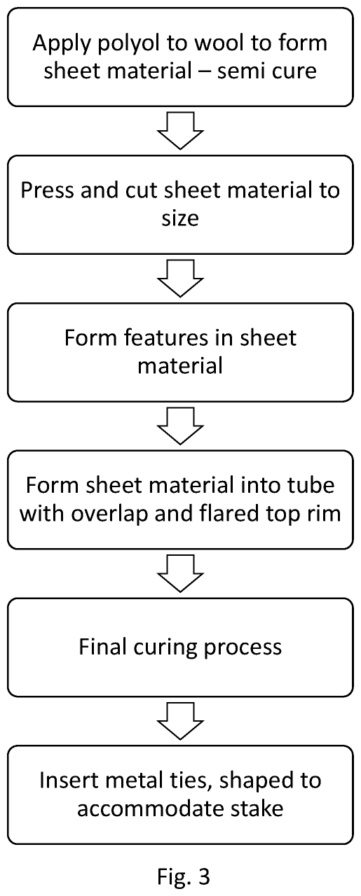

FIG. 3 broadly outlines the process by which the tree shelter is constructed.

First, the wool/CNSL and castor nut oil polyol TPU sheet material is formed. In one exemplary process, the wool is provided as a web (typically in a roll form). The wool web is drawn off the roll into a generally flat web, where it can be sprayed on one or both sides with a polyol composition to coat the wool fibres. The coated wool web is then semi-cured to form a natural, semi-cured TPU matrix in which the wool fibres are bound.

Next, the sheet material is pressed to reduce its thickness to the order or a few millimeters before it is cut to size, for example die cut, and the features, including the ventilation holes, the holes for the ties, the slits to form the lines of weakening and the flared or rounded top edge are formed. In some cases, some or all of these features can be formed prior to or at the same time as the sheet is cut to size.

The sheet material is then formed into a tube. To do this, the cut sheet is rolled around a mandrel with the ends of the sheet overlapping and the overlapping ends are pressed. As part of this process, the flared top rim is also formed in the tube. The formed tubes then go through a final curing process to fix the shape of the tube and bond the overlapping portions to one another.

Conventional isocyanate-based polymerization methods can be employed to form the TPU, as will be understood by the skilled person. In other examples, non-isocyanate polymerization methods may be used to form the TPU from the CNSL/castor nut oil polyol.

This tube formation step is completed, in this example, as part of the original manufacturing process.

Alternatively, the tree shelters can be packed and transported in a flat format and subsequently rolled into tubes at another site. This may be desirable, for example, where the tubes are being shipped long distances and transport costs can be significantly reduced by shipping the flat sheets.

Once the tubes are formed, the ends of the metal ties can be pushed through the attachment holes from the inside of the tube, ready for installation. Preferably, once inserted through the tube wall, the ends of the ties are twisted together and the tie is shaped so that it can easily be dropped over a stake. This makes installation quick and easy because all that is required is to drop the tree shelter into place (e.g. over a sapling tree), with the ties around the stake, and then for the installer to add a few more twists to the metal tie to tighten it against the stake.

To install the shelter, the wooden stake is driven into the ground adjacent a newly planted sapling tree. The shelter is then placed over the tree with the stake arranged against the double-walled portion of the tube and with the wire ties around the stake. Additional turns are then applied to the wire tie to secure the ties around the stake, pulling the wall of the tree shelter against the stake and securing it in place.

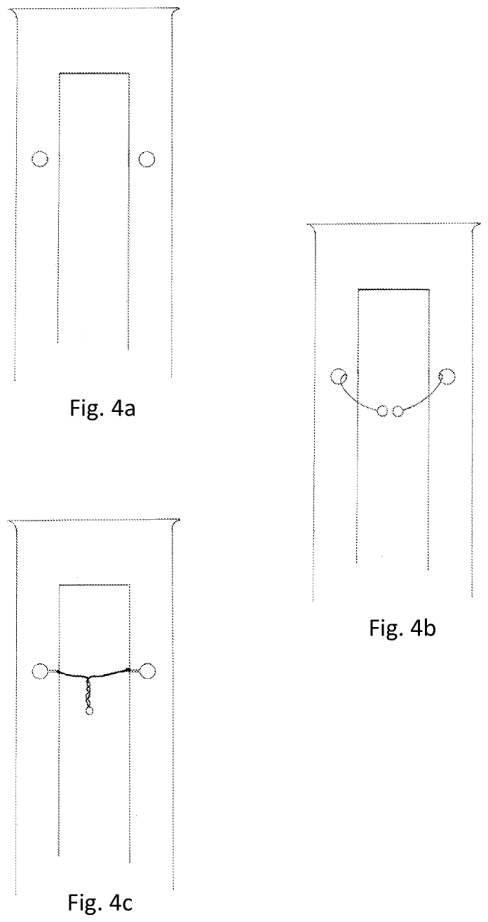

As shown in FIG. 4a, the attachment holes are spaced either side of the stake, so that inner edges of the holes are offset to opposite sides of the stake. This means that as the metal tie is initially brought around the stake, the tie is held away from the stake where is passes through the holes (as seen in FIG. 4b). However, as the metal tie is tightened, as seen in FIG. 4c, the metal tie cuts into the tree shelter wall adjacent the inner edges of the attachment holes, until it is pulled tightly against the stake. This attaches the tree shelter very securely to the stake.

Tree shelter stakes typically have a 25 mm square cross-section. Consequently, the inside edges of the attachment holes are preferably spaced apart by a minimum of about 30 mm, more preferably by a minimum of about 35 mm, 40 mm or more. Generally, it will not be desirable for the holes to be spaced apart by more than 50 mm, as the slits cut by the wire tie as it is tightened could be great long enough to start to affect the integrity of the tube wall.

The attachment holes may be formed in single-layer portions of the wall, either side of the overlapping, double wall portion that is to be placed adjacent the back of the stake. The metal tie can cut more easily into the single thickness wall.

For larger tree shelters, 32 mm stakes may be used and the spacing of the attachment holes for tree shelters to be used with these stakes can be set accordingly.

In addition to providing protection for saplings and small trees, it is important that the tree shelter provides an appropriate environment for plant growth. In particular, as well as providing adequate ventilation, it is important to ensure that sufficient light reaches the plant within the shelter.

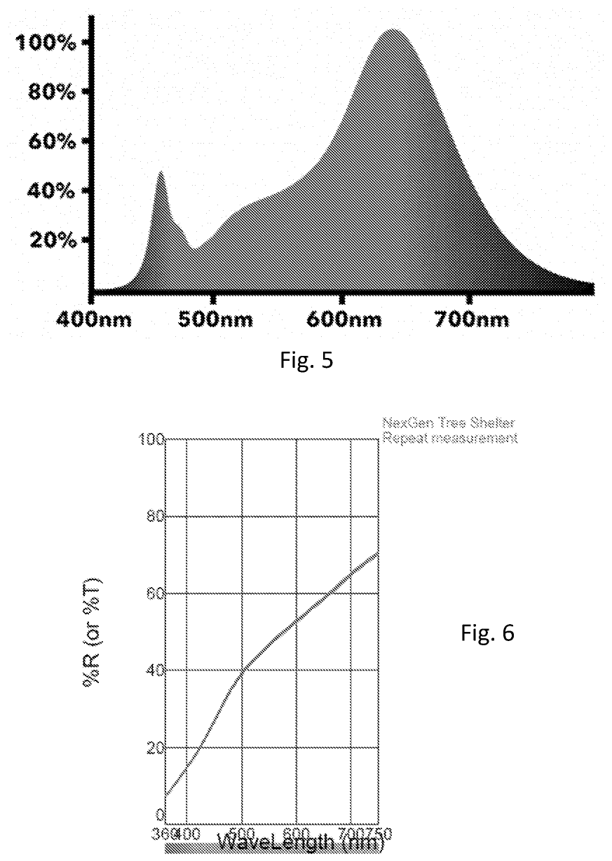

In addition, it is recognized that the spectrum of the transmitted light is important, as different wavelengths of light are more or less important to plant growth. For example, the red light wavelengths (600-700 nm) are among the most effective for stimulating photosynthesis and promoting biomass growth. With this in mind, FIG. 5 shows a preferred light transmission spectrum for the walls of a tree shelter.

By appropriate design of the tree shelter wall material, the walls can be engineered to transmit an adequate level of light. Typically, it is adequate if the walls transmit 70% to 80% of incident light.

FIG. 6 shows light transmission spectrum results from a test of a material made in accordance with an embodiment of the invention, using wool and a natural CNSL and castor nut oil polyol TPU binder. It can be seen that this combination of materials can effectively transmit light in the important 600-700 nm spectrum.

As the tree grows, the tree shelter tube and the metal ties will slowly degrade over a period of, typically, 5 to 7 years (depending on environmental conditions) and will eventually fall away or be forced apart by the tree from the now established tree and harmlessly continue to degrade on the ground, along with the metal ties.

Advantageously, as discussed above, the wool and CNSL/castor nut oil polyol TPU binder break down to release nitrogen, CO² and H²O as they degrade, helping to support plant growth.

If the tree grows sufficiently to press against the walls of the shelter before it has broken away through degradation of the tube and ties, the shelter expands and breaks apart along the split lines, thus avoiding any constraint on tree growth.

The skilled person will understand that various modifications and additions can be made to the examples described above without departing from the spirit and scope of the present invention.

1. A tree shelter comprising an elongate tubular body having a wall formed from a biodegradable material comprising a natural fibre substrate and a matrix of a natural binder in which the fibres are held;
wherein the natural fibre is wool.

2. A tree shelter according to claim 1, wherein the natural binder is a plant or insect derived natural binder.

3. A tree shelter according to claim 2, wherein the binder is derived from a natural plant based polyol.

4. A tree shelter according to claim 3, wherein the binder is derived from a cashew nut shell liquid (CNSL) based polyol, a castor nut oil based polyol or a combination of a cashew nut shell liquid (CNSL) and castor nut oil based polyol.

5. A tree shelter comprising an elongate tubular body having a wall formed from a biodegradable material comprising a natural fibre substrate and a matrix of a natural binder in which the fibres are held, wherein
the natural fibre is selected from the group consisting of: wool, recycled wool, goat hair, alpaca and angora, or a combination of any two or more of these fibres; and
the natural binder is derived from a cashew nut shell liquid (CNSL) and castor nut oil based polyol.

6. A tree shelter according to claim 5, wherein the natural fibre is wool.

7. A tree shelter according to claim 1, wherein the biodegradable material from which the tree shelter wall is formed is translucent or transparent.

8. A tree shelter according to claim 1, wherein the wall of the elongate tubular body is formed from a sheet of the biodegradable material formed into a tube with opposite edge portions of the sheet overlapping one another to form a double thickness wall region in the formed tube.

9. A tree shelter according to claim 8, wherein the width of the double thickness wall region is at least 20 mm.

10. A tree shelter according to claim 8, wherein the wall region comprises attachment formations for use in attaching the tree shelter to a stake.

11. A tree shelter according to claim 10, wherein the attachment formations comprise at least one pair of holes extending through the sheet, whereby the tree shelter can be secured to a stake by passing opposite ends of a strap from within the tube through a respective hole to the outside of the tube around opposite sides of the stake and securing the ends of the strap together.

12. A tree shelter according to claim 11, wherein the tree shelter is intended for use with a stake having a predetermined width, inner edges of the at least one pair of holes being spaced from one another by a distance that is greater than the width of the stake, whereby when the strap is tightened around the stake, the strap cuts into the sheet adjacent the inner edges of the holes.

13. A tree shelter according to claim 11, further comprising the strap, wherein the strap is a metal tie.

14. A tree shelter according to claim 1, wherein a top end portion of the wall of the elongate tubular body is flared outwardly or rounded.

15. A tree shelter according to claim 1, comprising a plurality of ventilation holes extending through the wall of the elongate tubular body, wherein there are no ventilation holes in at least the bottom 0.45 m of the wall.

16. A tree shelter according to claim 1, comprising at least one longitudinal line of weakness in the wall of the tubular body extending the full height of the wall.

17. (canceled)

18. (canceled)

19. A biodegradable sheet material comprising a natural fibre substrate and a matrix of a natural binder in which the fibres are held, wherein:
the natural fibre is wool; and
the binder is derived from a natural plant based polyol.

20. A biodegradable sheet material according to claim 19, wherein comprising a natural fibre substrate and a matrix of a natural binder in which the fibres are held, wherein:
the natural fibre is selected from the group consisting of: wool, recycled wool, goat hair, alpaca and angora, or a combination of any two or more of these fibres; and
the binder is derived from a cashew nut shell liquid (CNSL) and castor nut oilbased polyol.

21. A tree shelter according to claim 1, wherein the natural fibre substrate and binder are selected such that when they degrade they break down to form nitrogen, CO² and H²O.
